(19) United States
(12) Patent Application Publication
(10) Pub. No.: US 2011/0110109 A1
(43) Pub. Date: May 12, 2011

(54) Two section light rack

(76) Inventor: Han-Ming Lee, Hsin Chu City (TW)

(21) Appl. No.: 12/590,399

(22) Filed: Nov. 9, 2009

(51) Int. Cl. F21V 21/08

(52) U.S. Cl. 362/396

(57) ABSTRACT

The present invention relates to a two-section light rack and in particular to one in which the light rack bracket adopts the combined structure whereby the upper section and lower section are made of different materials, the main improvements being: the lower section of the light rack of the general LED bracket is bent in the reverse direction for embedding, clamping and positioning of the upper end of the other conducting pin and insulating resin is used to seal the I body at the bottom of the lamp body to form the light stud. As the conducting pin is made of red copper and bronze of good conductivity, the use of copper at the bracket at the top may be avoided and it may be replaced by iron plated copper and iron plated silver so as to reduce the consumption of precious metal.

### BACKGROUND OF THE INVENTION

The traditional power saving light source of LED lamp has become the mainstream of the lighting fixture industry and is widely used in various lighting applications. In the ordinary LED lamp structure shown in FIG. 6, the integrated copper bracket is provided with a chip cup at the top containing the chips to allow the input power at the bottom to create the light source effect. In view of surge in the demand for precious metal copper around the globe and limited copper resources, how to reduce the cost and improve the competitiveness of the business has become an urgent problem to be solved.

### SUMMARY OF THE INVENTION

The primary purpose of the present invention is to provide a two-section light rack and in particular to one in which the lower end of the light rack of the bracket is bent in the reverse direction for embedding, clamping and positioning of the upper end of the other conducting pin so as to reduce the consumption of precious metal copper significantly.

The secondary purpose of the present invention is to provide a two-section light rack and in particular to one in which the lower end of the light rack of the bracket is bent for clamping of the conducting pin and the insulating resin is used to seal the bottom of the light lamp body into a light stud of desired shape so as to provide light socket of any specification.

Another purpose of the present invention is to provide a two-section light rack and in particular to one in which the structure that connects the conducting pin at the lower end of the light may also be riveted y copper pipe and electrode welding (welding) and bundling so that the upper end and the lower end are made of different materials.

### BRIEF DESCRIPTION OF THE DRAWINGS

FIG. 1 is a 3D diagram of the present invention.

FIG. 2 is a schematic diagram of the components of the present invention.

FIG. 3 is a perspective 3D diagram of the present invention.

FIG. 4 is a schematic of another embodiment of the light stud of the present invention.

FIG. 5 is a schematic of another embodiment of the conductive pin of the present invention.

FIG. 6 is a schematic of the traditional structure.

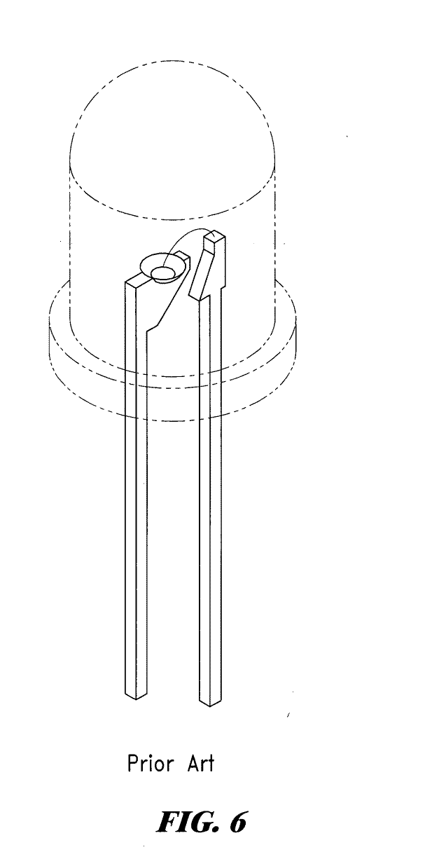

### DETAILED DESCRIPTION OF THE PREFERRED EMBODIMENT

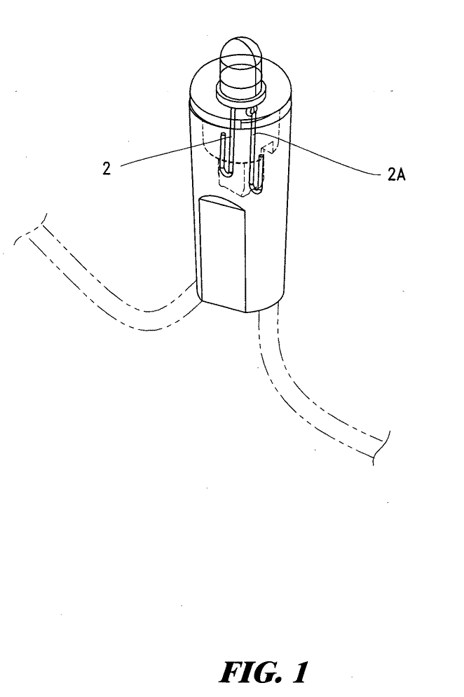

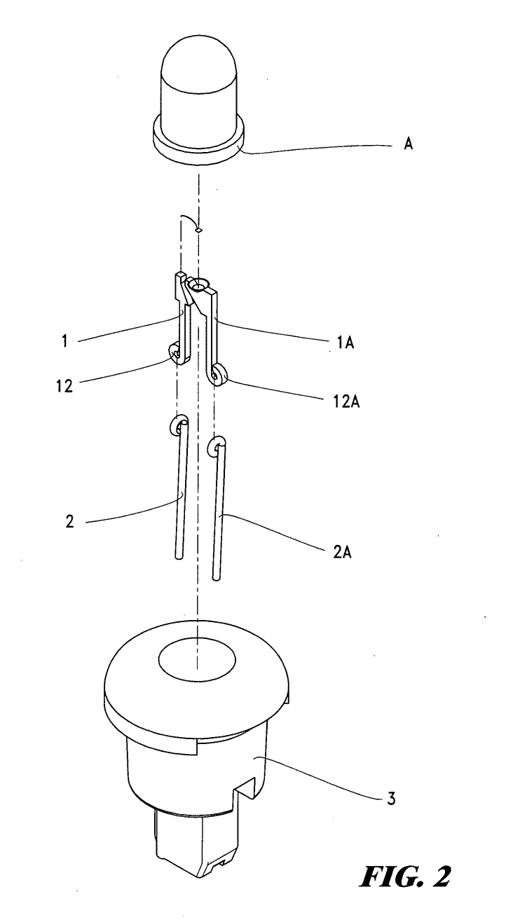

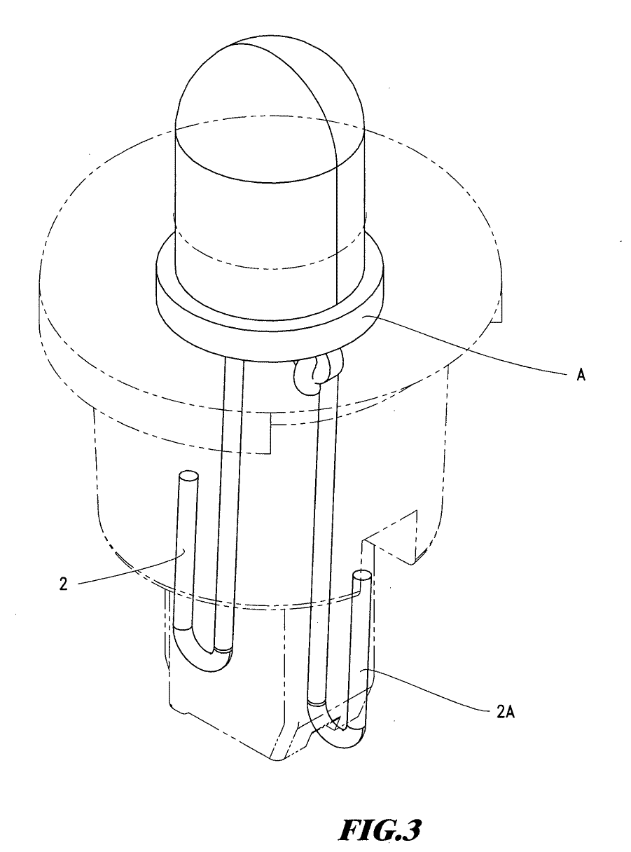

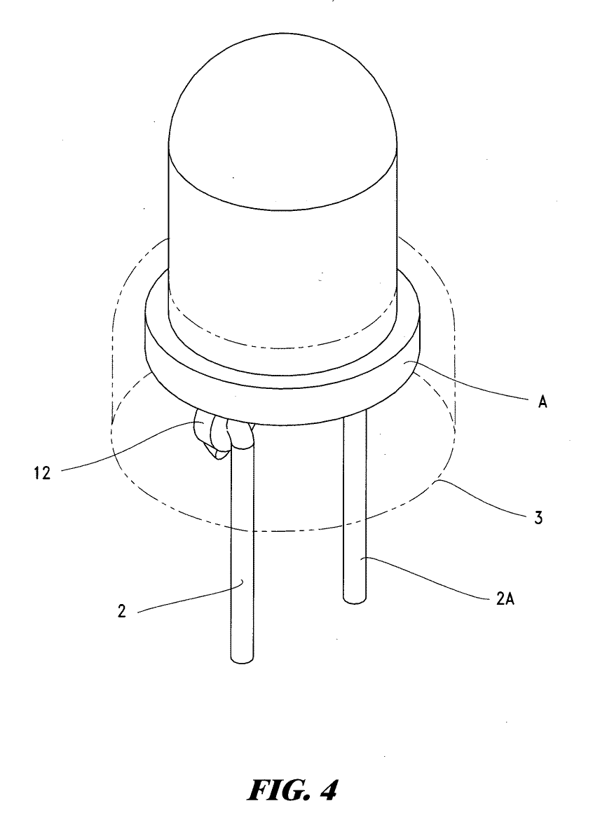

Please refer to FIG. 1 through FIG. 4. The present invention relates to a two-section light rack, the main improvements being: the bracket light rack 1 and 1A are light rack made of conducting iron plated copper and iron plated silver, the lower end of the light rack is designed with rack 12 and 12A bent in the reverse direction; the conducting pins 2 and 2A are made of precious metal material like red copper and bronze of good conductivity, and its upper end is provided for embedding into the lower end of the light rack for bending the rack 12 and 12A for clamping and positioning; the light stud 3 is insulating resin for sealing the expansion ring at the bottom of the lamp body A, bending the rack 12 and 12A and clamping the conducting pin 2 and 2A, and the I shaped body is sealed. The convenience of connecting and combining light socket of any specification may be provided to replace the bracket at the top with other materials so as to achieve the industrial application of reducing the consumption of the precious metal.

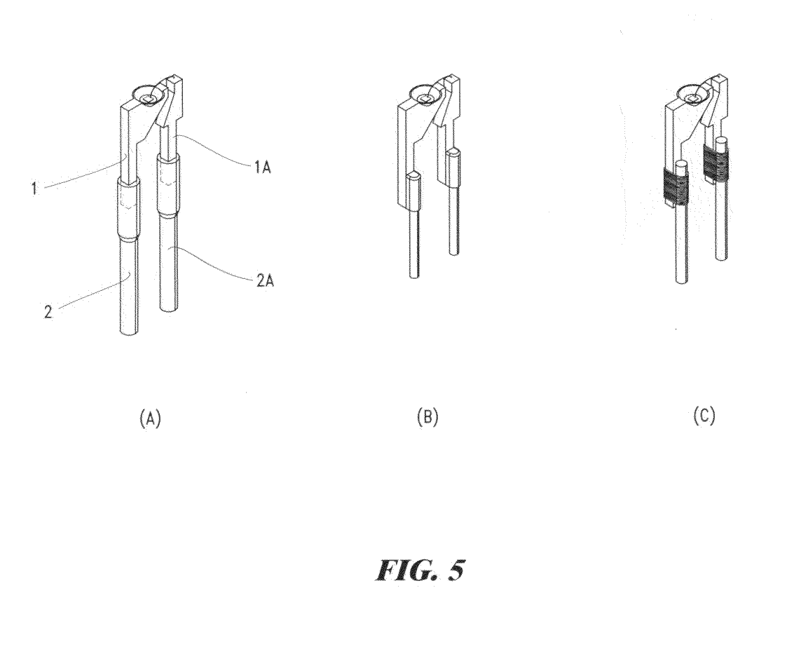

Please refer to FIG. 5 for another embodiment of the present invention. The bent rack 12 and 12A at the bottom of the bracket light rack 1 and 1A are provided for clamping of the conducting pins 2 and 2A. The bent rack 12 and 12A may be omitted and changed to be connected by means of riveting with copper pipe (A), electrode welding (welding) (B) and bundling (C) as shown in the figure so that the upper end and the lower end are made of different materials.

I claim:

1. A two-section light rack, the main improvements being: The light rack is conducting light rack made of iron plated copper and iron plated silver, and the lower end of the light rack is designed with bent rack in the reverse direction; The conducting pin is made of precious metal like red copper and bronze of good conductivity, and its upper end is provided for embedding of the bent rack at the lower end of the light rack, clamping and positioning; The light stud is insulating resin for sealing the expansion ring at the bottom of the lamp body, bending the rack and clamping the conducting pin, and the I shaped body is sealed to form the light stud; The design of structure that connects the other conducting pin is provided at the lower end of the light rack, and the convenience of connecting and combining light socket of any specification may be provided to replace the bracket at the top with other materials so as to reduce the consumption of the precious metal significantly.

2. The two-section light rack according to claim 1, wherein the structure that connects the conducting pin at the lower end of the bracket may be connected by means of riveting with copper pipe, electrode welding (welding) and bundling, etc.

3. The two-section light rack according to claim 1, wherein the light stud may be of the structure in any shape so that the convenience of combining the light socket of any specification is provided.
